(19) United States
(12) Patent Application Publication
(10) Pub. No.: US 2019/0163203 A1
(43) Pub. Date: May 30, 2019

(54) METHOD AND APPARATUS FOR VEHICLE ASSISTED PET TRACKING

(71) Applicant: FORD GLOBAL TECHNOLOGIES, LLC, Dearborn, MI (US)

(72) Inventors: Hamid M. GOLGIRI, Dearborn, MI (US); Michael HRECZNYJ, Livonia, MI (US); Vivekanandh ELANGOVAN, Canton, MI (US); Albert BOEHNLEIN, Ypsilanti, MI (US); Erick LAVOIE, Dearborn, MI (US); John VAN WIEMEERSCH, Novi, MI (US); Thomas HERMANN, Troy, MI (US)

(21) Appl. No.: 15/824,124

(22) Filed: Nov. 28, 2017

(51) Int. Cl. G05D 1/02; H04W 4/02; B60Q 5/00; A01K 11/00; A01K 27/00; A01K 29/00; A01K 15/02

(52) U.S. Cl. CPC G05D 1/0278; H04W 4/02; B60Q 5/005; H04W 4/008; A01K 27/009; A01K 29/005; A01K 15/023; A01K 11/008

(57) ABSTRACT

A system includes a processor configured to receive a tether activation instruction, including a range. The processor is also configured to wirelessly communicate with a mobile wireless module, responsive to the activation instruction. The processor is further configured to track the mobile wireless module as the module travels and issue an alert when the tracking reveals that the mobile wireless module has reached an outer edge of the range, measured from a processor-location.

### TECHNICAL FIELD

The illustrative embodiments generally relate to methods and apparatuses for vehicle assisted pet tracking.

### BACKGROUND

Vehicular autonomy provides a new level of freedom for occupants. With some (or eventually all) driving tasks taken out of the hands of occupants, people can focus more on enjoying a ride. Vehicles may communicate with each other to avoid collisions, but vehicular communication can be used for communicating with other entities as well. This sort of communication could also facilitate vehicle-assisted human decision making and tasks.

Eventually, when vehicles can drive themselves, people have the ability to assign autonomous tasks to vehicles as well. This could include, for example, going to the store to retrieve groceries or performing other tasks that are assisted, but not done solely, by a vehicle today. Accommodation for a variety of these sorts of tasks can be planned in advance with respect to autonomous vehicles.

### SUMMARY

In a first illustrative embodiment, a system includes a processor configured to receive a tether activation instruction, including a range. The processor is also configured to wirelessly communicate with a mobile wireless module, responsive to the activation instruction. The processor is further configured to track the mobile wireless module as the module travels and issue an alert when the tracking reveals that the mobile wireless module has reached an outer edge of the range, measured from a processor-location.

In a second illustrative embodiment, a system includes a processor configured to receive a tether activation instruction. The processor is also configured to wirelessly communicate with a mobile wireless module, responsive to the activation instruction and instruct a vehicle to follow the mobile wireless module as the module travels.

In a third illustrative embodiment, a system includes a processor configured to receive a wireless signal indicating a pet GPS location. The processor is also configured to provide navigation to a road-location within a predetermined distance of the GPS location. The processor is further configured to continue wireless signal receipt as a vehicle travels to the road-location. Also, the processor is configured to provide new navigation to a new road-location, responsive to a new GPS location deviating from a previous GPS location by more than a predetermined threshold, until the vehicle reaches a most recently provided road-location.

### BRIEF DESCRIPTION OF THE DRAWINGS

FIG. 1 shows an illustrative vehicle computing system;

FIG. 2A shows an illustrative process for tag-waking;

FIG. 2B shows a second illustrative process for tag-waking;

FIG. 3 shows an illustrative process for pet tethering; and

FIG. 4 shows an illustrative process for pet tracking.

### DETAILED DESCRIPTION

As required, detailed embodiments are disclosed herein; however, it is to be understood that the disclosed embodiments are merely illustrative and may be incorporated in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

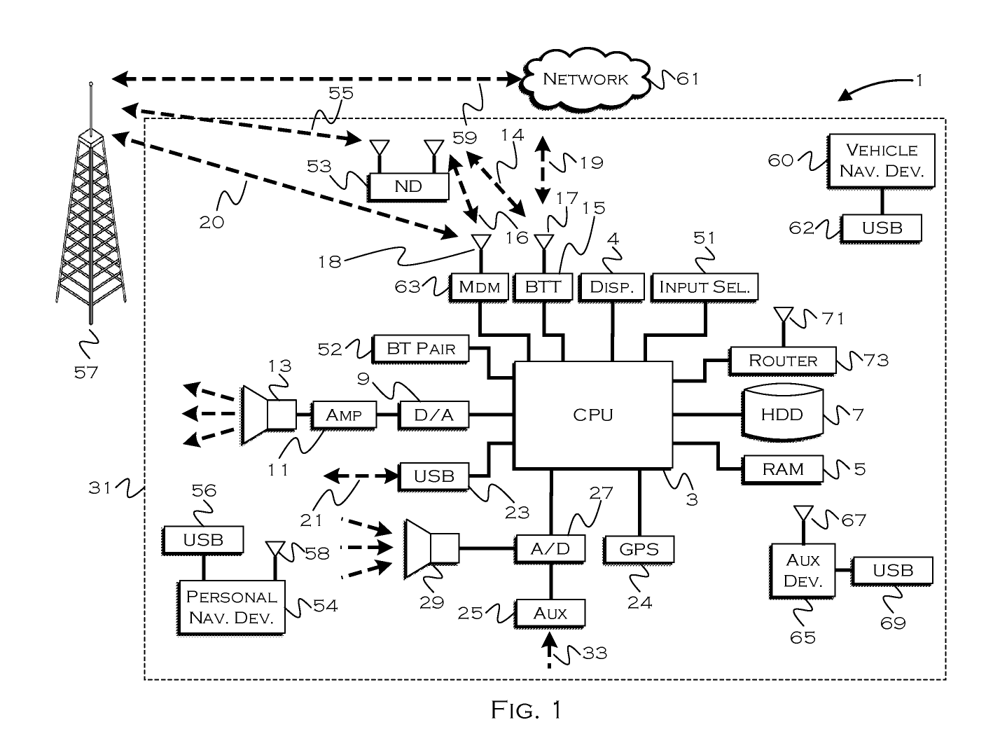

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touchscreen display. In another illustrative embodiment, the interaction occurs through button presses, spoken dialog system with automatic speech recognition, and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be transmitted to a remote BLUETOOTH device such as Personal Navigation Device (PND) 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device (hereafter referred to as ND) 53 can then be used to communicate 59 with a network 61 outside the vehicle 31 through, for example, communication 55 with a cellular tower 57. In some embodiments, tower 57 may be a Wi-Fi access point.

Exemplary communication between the ND 53 and the BLUETOOTH transceiver 15 is represented by signal 14.

Pairing the ND 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with ND 53. Alternatively, it may be desirable to include an onboard modem 63 having antenna 18 in order to communicate 16 data between CPU 3 and network 61 over the voice band. The ND 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). BLUETOOTH is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, the ND 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broadband transmission and the system could use a much wider bandwidth (speeding up data transfer). In yet another embodiment, the ND 53 is replaced with a cellular communication device (not shown) that is installed to vehicle 31. In still another embodiment, the ND 53 may be a wireless local area network (LAN) device capable of communication over, for example (and without limitation), an 802.11g network (i.e., Wi-Fi) or a Wi-Max network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

With a paradigm shift towards autonomous vehicles and ride sharing in the near future, the environments and activities on the insides of vehicles are likely to be more chaotic. The changes could include, for example, more people inside a vehicle on average, frequent vehicular ingress/egress, occupants drinking alcohol, shopping online, exercising, playing games, watching movies, and many other activities that are currently not permissible, common or even possible in a vehicle. With these sorts of changes, it will be more difficult to keep track of a pet that a user brings along with them in a vehicle, among other things. And, if the pet exits the vehicle, a human may not be in control to recognize the change in situation and halt the vehicle until the pet can be retrieved. With regards to purely autonomous vehicles, use cases may arise in which the user will not be in the vehicle along with a pet, but still desires to keep track of the pet (e.g., using the vehicle as a “dog walker”).

Using small BLUETOOTH Low Energy (BLE) transceivers, or other similar low energy transceivers, it is possible, to a certain extent, to determine the location of objects with respect to each other at short range (known as localization). Vehicles may be equipped with an array of BLE or similar antennas that allow for localizing a user's phone either on the inside or outside of the vehicle for the purposes of having a phone act as a passive/wireless key. The technology behind the feature is not phone-specific, however, and could also be used to locate a BLE tag that resides on a pet. To further enhance this concept, a small GPS module can also be incorporated into the tag.

A BLE+GPS tag can be made small enough to fit the form factor of a pet collar ID tag. This tag will allow the user to know whether their pet is inside vs. outside a vehicle, and provide a fairly accurate GPS location, at short-to-medium range, via their phone. Optionally, the tag can include a cellular module, allowing it to provide both GPS location, and localization with respect to a vehicle, whether the user is nearby or remote.

GPS modules and/or cellular modules may consume fairly large amounts of energy compared to other low-power devices. Since it is probably not going to be common to place large battery cells on any pet-collars, due to size and weight of the cells, it may be advisable to have high-energy components sleep until they are useful (e.g., when a signal from the component is needed).

The following illustrative embodiments provide several illustrative examples of tag-waking, which is planned wakeup of an electronic component or module based on conditions indicating utility of the signal therefrom. While the examples show possible wakeup strategies, the broader concept is to provide for tag-waking or component-waking when under conditions where a signal may be useful.

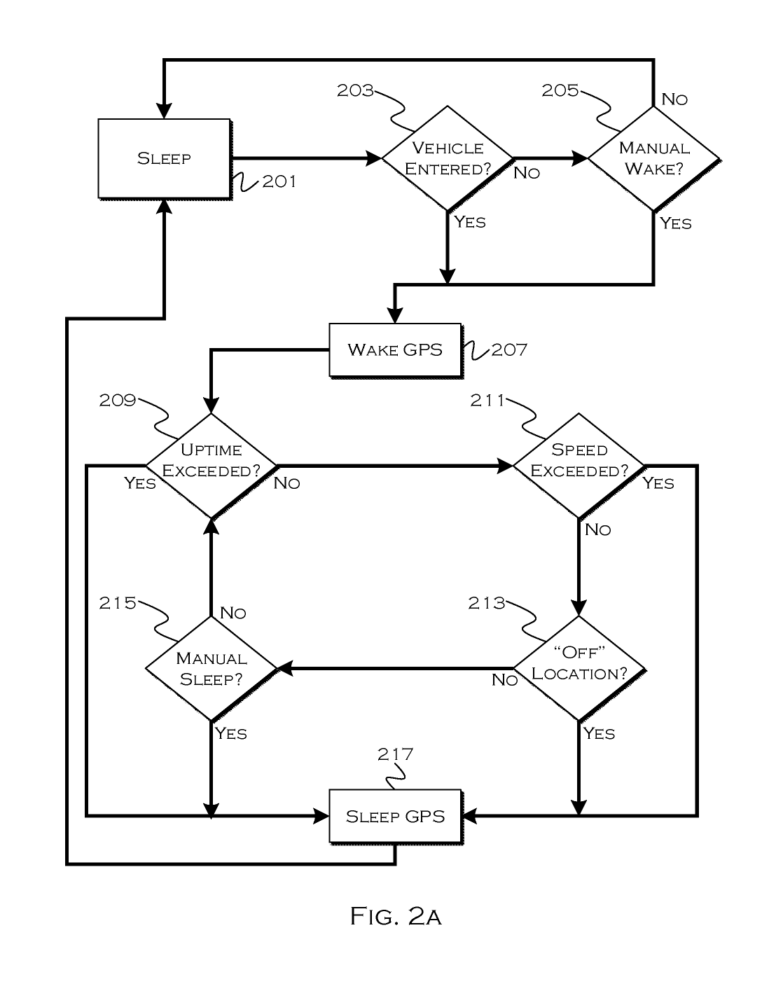

FIG. 2A shows an illustrative process for tag-waking. In this example, the process executes with regards to a collar or tag that includes a GPS module which defaults to a “sleep” state (unpowered). One or more conditionals are capable of causing the tag to wake, which will power the GPS module. Since the GPS module will typically have a warm-up period before it can report a signal, the opportunity for immediate reporting is not always present. But keeping the module powered at all times in order to have a signal at all times can severely tax a battery. The proposed example allows limited GPS (or other high energy module) usage and prevents an owner from having to charge a pet collar nightly.

In this example, the process begins when a GPS module is in a sleep 201 mode. This will be the typical state for the module in this example, and the “wake” strategy could be applied to other components of the collar as well, perhaps with varied conditionals depending on what function the component facilitates. In this example, the process attempts to have the module in a full wake state prior to the owner actually needing the signal.

There are two conditionals for enabling the module in this example, whether the collar (and thus the pet) enters the vehicle 203 and/or whether the owner manually engages the module 205. If either conditional is met, the process instructs 207 the GPS module to wake, and the GPS module remains in a wake state until a further conditional is met.

Sleeping states can be achieved with the GPS module through the occurrence of further conditionals, which in this example relate to protracted up-time 209, excessive speeds 211, the pet being in an “off” location 213 or a manual sleep command 215.

If the pet is in the vehicle for a long period of time, or if the collar is active for a long period of time, the collar may revert to a sleep mode. This can preserve battery life for when the collar is actually needed, and the duration can be set to a reasonable expectation for a journey. This aspect may not be as common, as it has the possible function of turning off the collar while the collar is still needed. Nonetheless, it is an option for putting the collar into sleep mode.

A similar downtime function can be achieved by shutting down the collar when a vehicle exceeds a certain speed, and then re-waking the collar when the vehicle slows down. Since a pet is less likely to exit a vehicle at excessive speeds, the collar provides very limited functionality while the vehicle is traveling along a highway, for example. But, when the vehicle slows, a pet could leap from a door or window, and thus the collar could be re-engaged at slower speeds if it were disabled at higher speeds.

Owners may also have “off” locations associated with a collar, such as a home location. In this example, if the collar had been awakened, and then the pet remained within a home geo-fence for a period of time (as measured by the collar), the collar may assume the user is also home and does not need the collar to report GPS coordinates, since the user has ceased traveling with the pet and presumably knows where the pet is located. A threshold delay may also be associated with the home coordinates, so that the collar is not immediately put into sleep mode after activation, if the pet enters the vehicle while the vehicle is in a home location.

Finally, as with activation, the user can use a phone application or similar application to manually put the collar into sleep mode. This will disengage and sleep the GPS or other module, so the owner can manually preserve power as the owner deems appropriate. Any transition into sleep mode may be conveyed back to an owner device (or a warning prior to entry), to allow the owner to manually enable or prevent sleeping if the functionality of the module is still needed.

In some examples, tags may also be activated responsive to accident detection (g-force sensing, direct notification) or even when a pet speed exceeds a certain speed (independent of a vehicle speed, and likely indicating a running pet). Certain activation conditions can cause longer activation periods as well, although there may always be a reason to mitigation activation periods in the interest of battery preservation. Accordingly, many strategies will attempt to accommodate both as best as possible.

FIG. 2B shows a second illustrative process for tag-waking. This is an example of an alternative to the preceding methodology, and neither of the two methods are meant as exclusive or inclusive (together) of all the ways to wake a sleeping module.

In this example, a collar includes both a BLE module and a GPS module. When the GPS module is in sleep 221 state, the BLE module is still active and the process on the collar is actively determining 223 whether or not the phone or other user device is within range of the collar. If the BLE communication signal between the user device and collar is lost (indicating pet movement out of range), the process can wake 225 the GPS module on the collar.

This situation essentially sets up a system whereby the GPS module wakes when a pet travels out of BLE or other short range signal strength of an owner, since those situations are presumably when the owner would want to activate GPS. Again, accommodation via mechanisms such as a timer may be made, so that if, for example, the BLE signal was lost while the pet was at home, the collar would not activate and drain completely while the animal was at home. As with the other example, conditionals such as “home” or other conditionals can be used to sleep the collar, to avoid unexpected and unnecessary battery drain.

Another option would be to provide one or more base stations around a house that are perpetually powered, so the BLE communication between the collar and a base station functions as a proxy for the user device, even if the user leaves the house or powers down a phone. Then, only if the house power goes out or if the animal leaves the home/yard will the collar be powered. Sleep of the module is achieved when the BLE signal is re-established.

Other suitable examples of warm up and power down also exist, such as using crowd sourcing to have other phones and vehicles look for a specified tag signal. In this case, the tag could generally broadcast BLE signals, and only periodically wake and broadcast GPS signals, to preserve tag power if the pet were missing for an extended time period. The BLE signals could be detected by other vehicles or devices and the location of those vehicles or devices could be reported back to an identified owner.

In still another example, a vehicle could activate a GPS module when a pet exits the vehicle, and use onboard satellite information to precondition the tag, which might help diminish or terminate the warm up period. This can save both power consumption and time. Other sources of location data (e.g., any source with a current GPS signal) could be used to precondition the tag as well. This can include, but is not limited to, user phones and other devices equipped with location-detecting technology.

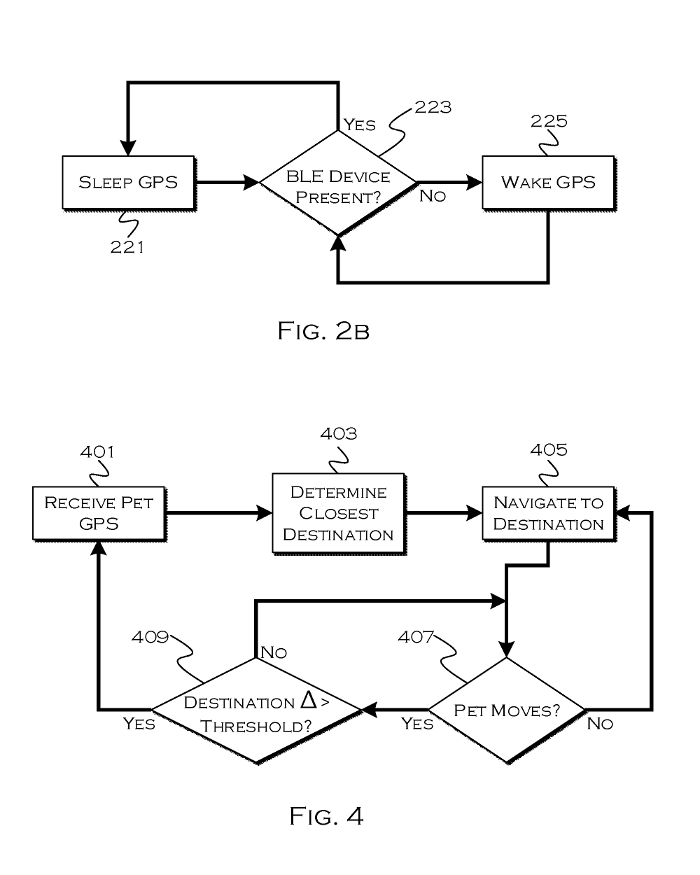

FIG. 3 shows an illustrative process for pet tethering. In this example, the pet can be tethered to a vehicle, or a vehicle can even be tethered to a pet. The process shown can accommodate both paradigms.

The process initially receives 301 a tether instruction, which could be input via a device or vehicle interface. In other examples, the tethering may be preset as automatic whenever the vehicle or pet is at or away from a certain location. In this example, the tether is for a defined 303 range, which could be a maximum BLE signal range or some other discrete range discernable by the vehicle, for example.

The process also receives 305 alert settings from the owner, which can create vehicular, owner device and even collar alerts. For example, if “maximum” alerts were set, a vehicle could sound a horn or other alarm, a vehicle could message an owner device, and a vehicle could send a “shock” instruction to a collar if the pet approached or exceeded a maximum range for specified duration after which the pet may be given a few warning pulses and then the system may going into increasing stronger levels of shock that are considered safe and human within the invisible fence industry standards. This could generally train the pet to stay proximate to the vehicle, which could allow the owner to let the pet roam nearby without fear of the pet running off. Even if the “negative” (shock and/or horn) training were not used, at least the owner could know when a pet had left the area. The process engages both a phone 307 which can track the pet via BLE (phone tether) and a vehicle 309 which can function as a tether when the pet is out of range of the phone.

While an animal is in range of both the phone and vehicle, both can track 311 the pet location. If the animal leaves the range of the phone, the vehicle can still track the location. At any time, or all the time, the vehicle can provide a breadcrumb or other trail for the user on the mobile device/phone. Also, if the animal is being tracked by the vehicle using a low energy signal with a limited range, the vehicle can instruct the collar to activate a GPS module and/or a cellular module provided thereto, if the animal approaches the edge of the low energy range. Or, as previously noted, merely breaking the low energy connection could be sufficient to trigger GPS/cellular activation.

In some examples, autonomous vehicles may actually follow 313 a pet to stay within tether range. This can cause the vehicle to slowly follow 315 a moving pet based on pet proximity, up until a point where following becomes impossible 319. If following is not possible, the process may open 319 a pet ingress (door, window, hatch, etc.) and may tether 321 the pet to a now stationary vehicle. Sounds or other enticements may be used to encourage the pet to enter into the vehicle through the open ingress. Further, the vehicle does not necessarily need a specified “range” when following a pet. Instead, the vehicle can move forward whenever a signal strength falls below a certain threshold. This functions to keep the pet in a certain proximity based on signal strength as opposed to a discreetly defined range.

Even if the vehicle is not following the pet (i.e., the pet is tethered to the vehicle, as opposed to the vehicle being tethered to the pet), the process may continually detect 323 signals from a collar, which could also include receiving GPS locations if the range went beyond a low energy signal. If the pet is at or approaching the edge 325 of a defined range, the process can issue 329 any of the alerts previously discussed. If the pet is not at the edge of the range, the process can continually or periodically provide 327 a breadcrumb trail to a user device, so the user generally knows where the pet is located.

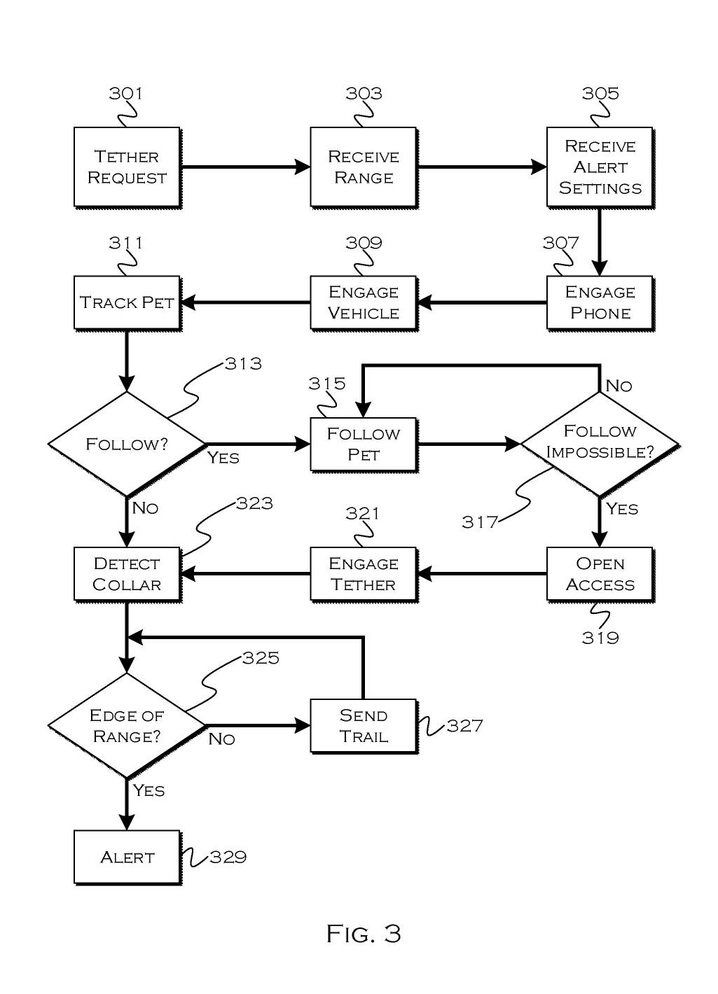

FIG. 4 shows an illustrative process for pet tracking. In this example, the vehicle can interact with signals received from a collar (GPS signals, for example) to route a vehicle to a pet location. The vehicle can drive itself to the location, or can guide an owner to a location. Since the vehicle should know both the road network and the pet location, the vehicle can determine road locations that closely correspond to pet locations and provide or alter navigation instructions accordingly.

In this example, a pet is presumed missing with an active GPS signal being either broadcast via cellular or shared back to an owner based on detection by other detection devices (phones/vehicles) within BLE, Wi-Fi, etc. range of the pet collar. The vehicle receives 401 pet coordinates and cross-refences those coordinates with a road network to determine 403 a road location closely corresponding to a pet location. The vehicle then provides 405 or directly navigates to the determined location.

Unlike traditional destinations, however, the pet may move and thus the road location could change. If the pet moves 407 (if a new deviated GPS signal is received), the process can determine 409 if the current destination is more than a predefined deviance from the new location. That is, if the pet is running in circles, the owner may still want to drive to the same location, but if the pet is running in a line, the owner may need a new road location in order to intercept the pet. The navigation cross-referencing can continue until the owner retrieves the pet, reaches the destination where the pet signal is located, etc.

Concepts like mobile-mesh and other ad-hoc networks can also be used to track pets. Vehicles can “report” detected pets, and a user or vehicle can travel to a reporting vehicle, while receiving update signals from other vehicles along the way. If the vehicles act in concert as a mesh network, the user can travel through the network of vehicles to a pet location, while receiving updates from vehicles now proximate to a pet, passed through the network.

Through use of the illustrative embodiments, pet owners can track, avoid and tether pets using digital signals. Battery life can be optimized, and the owner can have some assurance that a pet will not be struck by an AV or that a pet can even be found and/or retrieved by an AV. Many of the illustrative embodiments could also be used to keep track of persons under supervision of a caretaker, in a similar manner.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

1-11. (canceled)

12. A system comprising:
a processor configured to:
receive a tether activation instruction;
wirelessly communicate with a mobile wireless module, responsive to the activation instruction; and
instruct a vehicle to follow the mobile wireless module as the module travels, wherein a vehicle control module is configured, responsive to the instruction to follow, to move the vehicle towards the wireless module when a signal strength of a communication signal from the wireless module falls below a predefined threshold.

13. A system comprising:
a processor configured to:
receive a tether activation instruction;
wirelessly communicate with a mobile wireless module, responsive to the activation instruction;
instruct a vehicle to follow the mobile wireless module as the module travels;
determine that the vehicle should no longer follow the mobile wireless module based on an obstacle in a vehicle path; and
responsive to the determination, open a vehicle access for an animal.

14. The system of claim 13, wherein the processor is also configured to issue an enticement for the animal responsive to opening the access.

15. The system of claim 13, wherein the processor is further configured to:
issue an alert to a predefined user device responsive to the determination.

16. The system of claim 15, wherein the alert includes issuing an alert to a cellular phone.

17. The system of claim 15, wherein the alert includes sounding a vehicle horn.

18. The system of claim 15, wherein the alert includes sending an instruction to the mobile wireless module to issue a shock.

19. A system comprising:
a processor configured to:
receive a wireless signal indicating a pet-location;
provide navigation to a road-location within a predetermined distance of the pet-location;
continue wireless signal receipt as a vehicle travels to the road-location; and
until the vehicle reaches a most recently provided road-location, provide new navigation to a new road-location, responsive to a new pet-location deviating from a previous pet-location by more than a predetermined threshold.

20. The system of claim 19, wherein the processor is further configured to:
instruct a vehicle control module to navigate the vehicle to the most recently provided road-location; and
responsive to reaching the most recently provided road location, automatically open a vehicle access.
